(19) United States
(12) Patent Application Publication
(10) Pub. No.: US 2007/0146645 A1
(43) Pub. Date: Jun. 28, 2007

(54) COOLING DEVICE FOR USE WITH A PROJECTION APPARATUS

(75) Inventors: Chia-Jui Lin, Taoyuan County (TW); Hui-Chih Lin, Taoyuan County (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: DELTA ELECTRONICS, INC., Taoyuan County (TW)

(21) Appl. No.: 11/557,362

(22) Filed: Nov. 7, 2006

(30) Foreign Application Priority Data
Dec. 23, 2005 (TW) 094146112
May 25, 2006 (TW) 095118550

(51) Int. Cl. G03B 21/18; G03B 21/26

(52) U.S. Cl. 353/58; 362/294

(57) ABSTRACT

A cooling device for use with a projection apparatus is disclosed. The cooling device includes a first axial fan and a second axial fan which is disposed adjacent to the heat generating portion of a light source device. The second axial fan comprises an inner end and an outer end disposed on the opposite side of the inner end. An airflow guiding device is disposed onto the outer end, in which the guiding device comprises an airflow outlet and an airflow inlet with an area greater than that of the airflow outlet. The airflow inlet of the guiding device shields at least a portion of the outer end of the second axial fan.

This application claims priorities to Taiwan Patent Application Nos. 094146112 filed on Dec. 23, 2005, and 095118550 filed on May 25, 2006.

### CROSS-REFERENCES TO RELATED APPLICATIONS

Not applicable.

### BACKGROUND OF THE INVENTION

1. Field of the Invention

The present invention relates to a cooling device for use with a projection apparatus. In particular, the invention relates to a light source cooling device for use with a digital light processing (DLP) projection apparatus.

2. Descriptions of the Related Art

Projectors have been frequently used as display equipments in offices, homes, and conference rooms. Conventional projectors can fall into two categories: liquid crystal display (LCD) projectors or digital light processing (DLP) projectors. DLP projectors apply digital projecting and displaying technologies, in which digital video signals are received and a series of digital light-pulses are generated. In addition, DLP projectors employ a DMD (digital micromirror device), on which a plurality of micro mirrors are disposed. When lights generating from a light source are projected onto the DMD, the micro mirrors of the DMD immediately reflect the lights towards the projection lens for image formations.

To prevent damage to the optical elements or other electrical components due to heat accumulation, the heat generating from the light source of the DLP projectors needs to be removed by, for example, a cooling device. A well-designed cooling device also helps miniaturize the entire system.

In general, the light source of the DLP projector is an illuminant lamp, wherein the lamp employs leading wires for connecting the front and back foil, while maintaining the tiny gap therebetween. When the leading wires of the front foil and the back foil are electrically connected, the light source is promptly introduced through the tiny gap, in which a well known bulb is located as well. It is understandable that the bulb is the main heat generating portion of the light source. Specifically, stronger cooling airflows (i.e. larger quantities of airflows in a unit time, measured in ft³/min) are needed for cooling the bulb and maintaining it under a normal working temperature, which is generally lower than 900° (in Celsius). In addition, the lead wire, the front foil, and the back foil also need to be maintained under a normal working temperature, which is generally lower than 350° (in Celsius), to avoid overheating and resulting in lamp failure or explosion. The aforesaid temperatures also refer to the so-called threshold temperatures of a projector. The temperature is controlled by the amount and guiding ways of the cooling airflows. A secondary consideration in cooling the lamp is the pressure of the introduced airflows.

Conventionally, a blower fan is utilized for cooling a projector because of its high static pressure, which provides a higher velocity of airflows. Moreover, the blower fan can associate with a fan duct for cooling the bulb. Specifically, as shown in FIG. 1, a conventional DLP projection system comprising an axial fan 2 and a blower fan 4 is illustrated. The blower fan 4 associates with a fan duct 41, to guide a cooling airflow toward a bulb 111 located within a light source device 1. However, because the blower fan 4 is loud, the noise generating from the blower fan 4 is unfavorable under the desired amount of airflow. As expected, the noise of the entire system increases accordingly. Furthermore, the blower fan 4 adds an increased cost to the entire system and is only provided for cooling the bulb itself, rather than other optical elements or electrical components.

Given the above, an inventive cooling device that produces fewer noises and has smaller product dimensions, as well as decreased costs, needs to be developed in this field.

### SUMMARY OF THE INVENTION

The primary objective of this invention is to provide a cooling device for use with a projection apparatus. The cooling device employs two axial fans, in which one generates an airflow partially along an airflow guiding device and then towards the interior of the light source device for cooling. The mentioned design is capable of efficiently reducing system noises and promoting the amount of airflow from the inlet of the fans to enhance cooling efficiency; Another objective of this invention is to provide a cooling device for use with a projection apparatus. By replacing the conventional blower fans with two proximate axial fans, the costs of the entire product are reduced.

Still another objective of this invention is to provide a cooling device for use with a projection apparatus. By employing an axial fan to cool the bulb in a more sufficient way, the dimensions of the other axial fan can be diminished, whereby the final products are miniaturized.

Yet a further objective of this invention is to provide a cooling device for use with a projection apparatus. By employing the airflow guiding device and partially guiding airflows along the outer end of the second axial fan to cool the bulb, the remaining airflows that are not guided towards the bulb could still cool the system. That is, the axial fan can cool the bulb as well as provide cooling airflows for the system.

To achieve the above-mentioned objectives, the cooling device of the present invention comprises a first axial fan and a second axial fan. The first axial fan cools the system and a reflector of a light source device (i.e. where the bulb is located). The second axial fan is disposed on the side of the heat generating portion of the light source device. The second axial fan comprises an inner end, an outer end which opposes the inner end, and an airflow guiding device. Regardless of whether the first axial fan and the second axial fan are located on the same side or not, both of them are suitable for guiding an external airflow towards the light source device while simultaneously cooling other components behind the light source device. The airflow guiding device, comprising an airflow outlet and an airflow inlet which has a cross section area greater than that of the airflow outlet, is disposed on the outer end. The airflow inlet shields at least a portion of the outer end of the second axial fan. Thus, the airflow guiding device guides the external airflow towards the interior of the light source device for cooling the system.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view illustrating a conventional device utilizing a blower fan for cooling;

FIG. 2 is a schematic view illustrating a light source cooling device, which has two axial fans, for use with a DLP projection system of the present invention;

FIG. 3 is a schematic view illustrating the first preferred embodiment of the present invention, in which the second axial fan is assembled with the airflow guiding device;

FIG. 4 is a schematic view illustrating the frame of the second axial integrally formed with the airflow guiding device according to the present invention;

FIG. 5 is a schematic view illustrating the second preferred embodiment of the present invention, in which the second axial fan is assembled with the airflow guiding device;

FIG. 6 is a rear schematic view illustrating the airflow guiding device depicted in FIG. 5;

FIG. 7 is a schematic view illustrating the third preferred embodiment of the present invention, in which the second axial fan is assembled with the airflow guiding device;

FIG. 8 is a schematic view illustrating a practical assembly of the airflow guiding device of the present invention; and

FIG. 9 is a schematic view illustrating the best embodiment of the cooling device of the present invention.

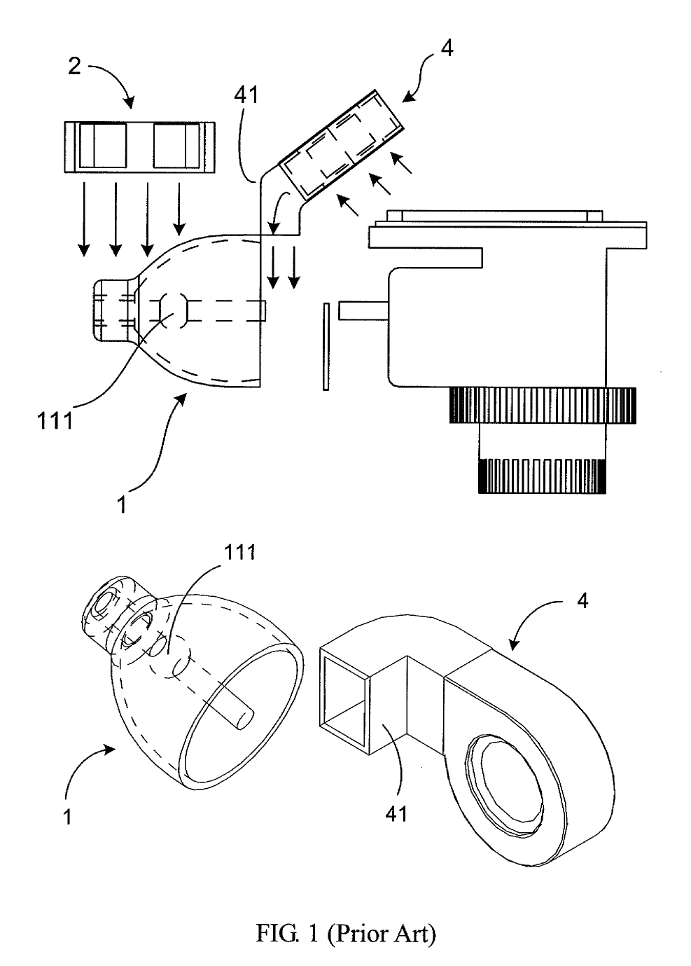

### DESCRIPTION OF THE PREFERRED EMBODIMENT

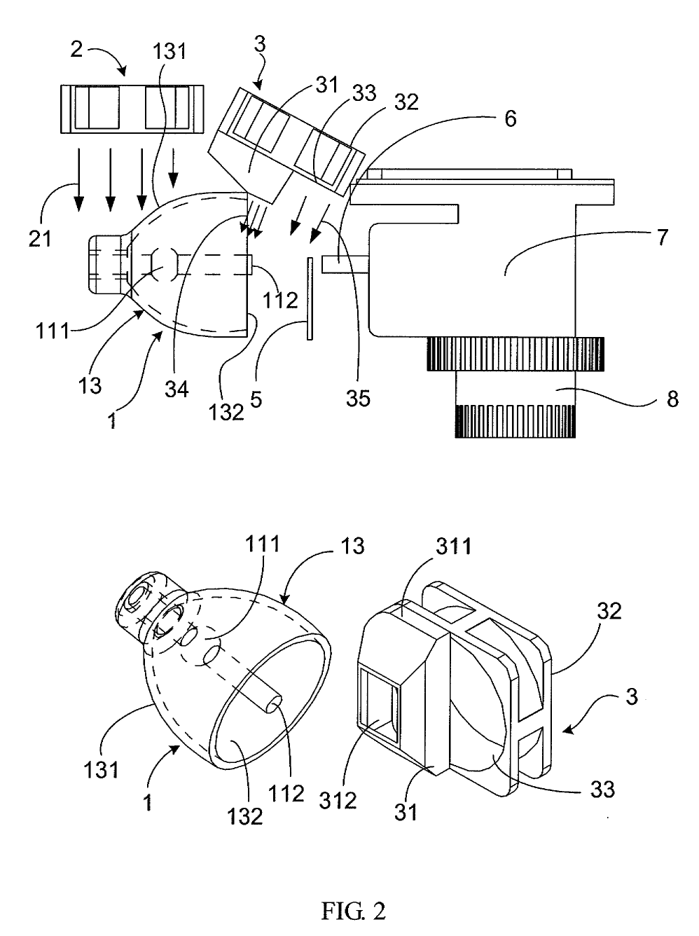

FIG. 2 is a schematic view illustrating a light source cooling device, which has two axial fans, for use with a DLP projection apparatus of the present invention. A light source device 1 is utilized to generate light beams. After traveling through the color wheel 5, the light beams are converted into different colors, for example, red (R), green (G), and blue (B). The light then travels through an integration rod 6 to be uniformed. Then, the uniform lights, handled by several optical components 7 (e.g. digital micromirror device, DMD), project outwards through the projection lens assembly 8 to form an image on the screen.

Usually, the light source device 1, for example, an illuminating lamp, is the principal heat generating component in the projection device. The lamp comprises a bulb 111, a lead wire 112, which is disposed in front of the bulb 111, and a reflector 13. The reflector 13 comprises a neck portion 131 and an opening 132. The bulb 111 is located in the neck portion 131 of the reflector 13 and the lead wire 112 is substantially located in the opening 132; thereby, the bulb 111 and the lead wire 112 co-define a heat generating portion. The first axial fan 2 guides the external airflow towards the neck portion 131 of the lamp. The cooling device is disposed adjacent to the bulb 111 and the lead wire 112, to efficiently cool the heating components within the lamp. It is understandable that the priority of cooling the entire system is to lower the temperature of the internal heat generating components.

The present invention substantially provides two axial fans for guiding an external airflow toward the light source device, while simultaneously cooling the entire system and the lamp. The first axial fan 2 is disposed in the projection apparatus and provides a cooling airflow both for the reflector 13 and the entire system. In general, the reflector 13 presents a gradually spreading shape towards the opening 132. If the temperature of the bulb 111 is extremely high, the temperature of the neck portion 131 of the reflector 13 is high as well. The first axial fan 2 generates a system airflow 21 to cool the exterior of the reflector 13 (especially the neck portion 131) and other components disposed behind the fans. The second axial fan 3 is disposed on the side of the light source device 1. Preferably, the second axial fan 3 is disposed in front of the light source device 1 to facilitate airflow 34 towards the bulb 111 and the lead wire 112 for cooling the interior of the lamp. The second axial fan 3 comprises an inner end 32 and an outer end 33 disposed opposite of the inner end 32. The cooling device further comprises an airflow guiding device 31 (or namely, a fan duct) disposed on the outer end 33 of the second axial fan 3 for guiding the airflows and altering the flowing velocity. The airflow guiding device 31 includes an airflow outlet 312 and an airflow inlet 311 with a cross section area greater than that of the airflow outlet 312, whereby presenting a tapered profile. Furthermore, the airflow inlet 311 shields at least a portion of the outer end 33 of the second axial fan 3.

The present invention employs partial or complete airflows generating from the second axial fan 3 to cool the heat generating portion (especially the bulb 111 and the lead wire 112). When the second axial fan 3 is assembled with the tapered airflow guiding device 31, airflows with higher velocity towards the bulb 111 and the lead wire 112 are provided. When the airflow guiding device 31 merely shields a portion of the outer end 33 of the second axial fan 3, not only are the bulb 111 and the lead wire 112 cooled, but also are other components in the system cooled by the other airflow generating from the unshielded portion of the outer end 33.

A preferred embodiment arranges (1) the airflow inlet 311 of the airflow guiding device 31 so that it substantially shields half of the outer end 33 of the axial fan, and (2) the airflow outlet 312 so that it is substantially disposed on the side of the heat generating portion. Thus, the airflow guiding device 31 guides the airflow through an opening 132 towards the interior of the lamp. An alternative embodiment is for the airflow inlet 311 of the airflow guiding device 31 to completely shield the outer end 33 of the axial fan. In this case, the airflow outlet 312 is substantially disposed on the side of the heat generating portion, guiding the airflow through the opening 132 to cool the heat generating portion.

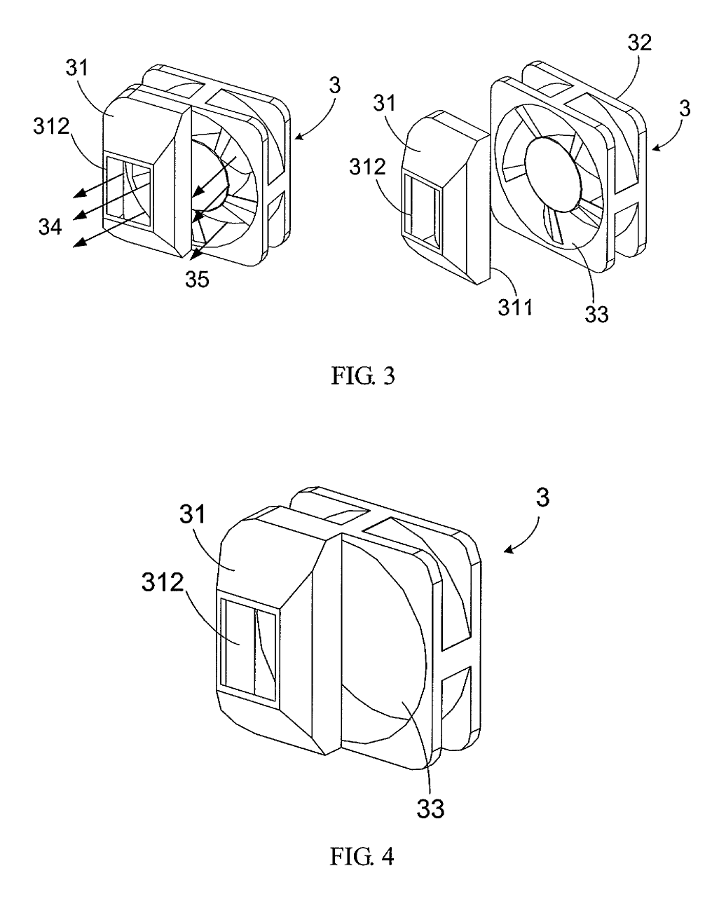

FIG. 3 illustrates the first preferred embodiment of the second axial fan 3 of the present invention, wherein the second axial fan 3 is assembled with the tapered airflow guiding device 31. The airflow is drawn from the inner end 32 of the second axial fan 3, and discharged at the outer end 33 of the second axial fan 3. The airflow is partially guided into the airflow inlet 311 of the airflow guiding device 31. The tapered airflow guiding device 31 can also assist in increasing the airflow velocity to generate a higher velocity of the bulb airflow 34 to cool the bulb 111 and the lead wire 112. Due to the partially shielded outer end 33, the unshielded portion is capable of generating a system airflow 35 for cooling other components in the system.

As shown in FIG. 4 in the aforesaid embodiment, the airflow guiding device 31 is integrally formed with the outer end 33 of the second axial fan 3. Thus, the airflow guiding device 31 can simultaneously generate the bulb airflow 34 and system airflow 35. Also, the integral design can simplify the complexities during device assembly.

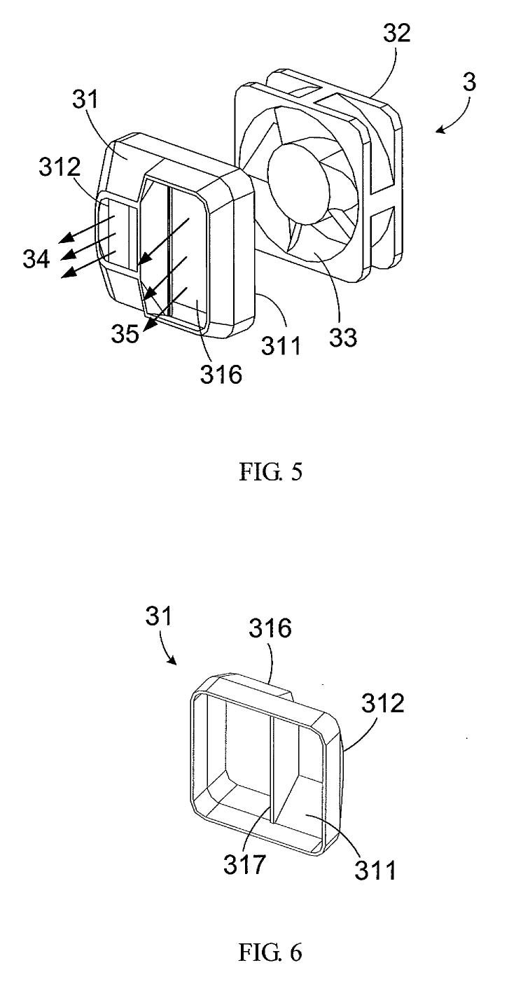

FIG. 5 illustrates the second preferred embodiment of the present invention. Substantially, the airflow guiding device 31 completely shields the outer end 33 of the second axial fan 3. Preferably, the airflow inlet 311 of the airflow guiding device 31 has a cross section area equal to that of the outer end 33 of the second axial fan 3. The airflow guiding device 31 further comprises a system airflow outlet 316. A partition (not shown) can be independently disposed between the airflow outlet 312 and the system airflow outlet 316. Alternatively, a guiding frame 317 can be disposed to define the airflow outlet 312 and the system airflow outlet 316. For separating the airflows, the partition or the guiding frame 317 can extend proximately from the outer end 33 of the second axial fan 3. Alternatively, the partition or the guiding frame 317 can extend a bit distance from the outer end 33 of the second axial fan 3 to form a gap between the guiding frame 317 and the outer end 33.

FIG. 6 is a rear elevational view of the airflow guiding device 31, detailing the structure of the airflow guiding device 31 of this embodiment. The airflow generated by the second axial fan 3 travels into the airflow guiding device 31. Through the partition or the guiding frame 317, the airflow would be subsequently separated into bulb airflow 34 or system airflow 35. Soon after, the bulb airflow 34 and system airflow 35 are respectively discharged from the airflow outlet 312 and the system airflow outlet 316, towards the interior of the light source device 1 and other components.

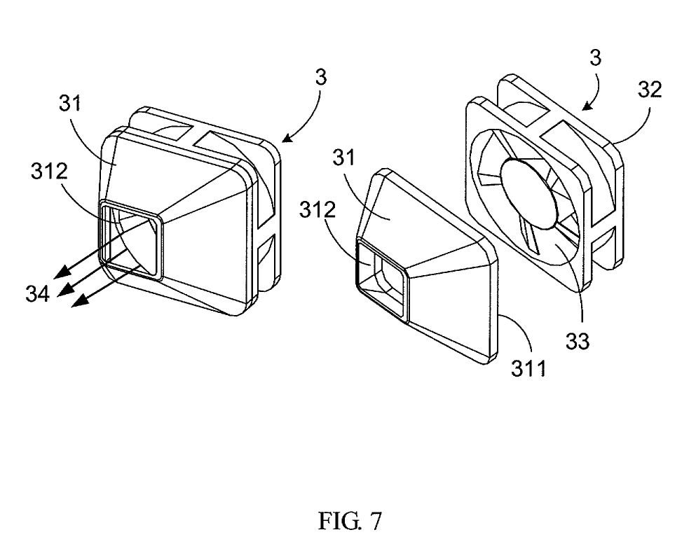

FIG. 7 is a schematic view illustrating the third preferred embodiment of the second axial fan 3 that is assembled with the airflow guiding device 31 of the present invention. The second axial fan 3 is assembled with the tapered airflow guiding device 31 to generate stronger bulb airflow 34 for the bulb 111 and the lead wire 112. The airflow guiding device 31 is characterized by completely shielding the outer end 33 of the second axial fan 3. In other words, the bulb airflow 34 generated from the external airflow by the second axial fan 3 is mainly used for cooling the heat generating portion (i.e. the bulb 111 and the lead wire 112).

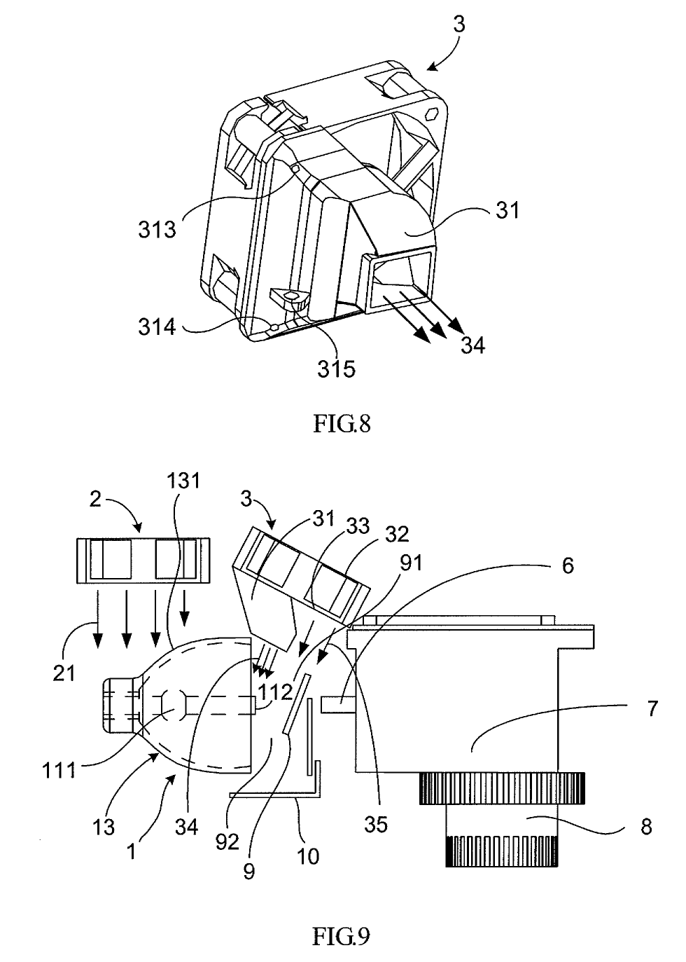

FIG. 8 is a schematic view illustrating a practical assembly of the second axial fan 3 with the airflow guiding device 31. The cooling device further comprises a first fastening device and a second fastening device. The first fastening device (preferably including a first fastening component 313 and a second fastening component 314 as shown in FIG. 8) mounts the airflow guiding device 31 to the outer end 33 of the second axial fan 3. The second fastening device (preferably a third fastening component 315 as shown in FIG. 8) mounts the airflow guiding device 31 to an optical engine chassis (not shown). The aforesaid arrangement verifies the precise position of the airflow guiding device 31. Thus, the bulb airflow 34 is guided more accurately into the reflector 13, resulting in an enhanced cooling reliability Furthermore, because the outer edge of the airflow guiding device 31 is aligned with the outer frame of the second axial fan 3, spatial arrangements are economized and airflow efficiencies are enhanced.

FIG. 9 illustrates the best embodiment of the present invention. The first axial fan 2 and the second axial fan 3 are preferably disposed on the same side of the light source device 1 for guiding the external airflow towards the light source device 1. The light source device 1 has an optical axis, with the mentioned heat generating portion disposed on the optical axis. Naturally, the bulb 111 and the lead wire 112 are located on the optical axis. The DLP projection apparatus further comprises a filter, for example, an ultraviolet infra-red (UV-IR) cut filter 9, and a guiding plate 10. The UV-IR cut filter 9 is disposed in front of the lamp. More precisely, the UV-IR cut filter 9 is disposed in front of the lead wire 112, and at an angle with the optical axis for facilitating airflow generating from the second axial fan 3. This arrangement could efficiently guide the bulb airflow 34 towards the bulb 111 and the lead wire 112 in the light source device 1 for cooling the heat generating portion. The guiding plate 10 is disposed on the side opposing the second axial fan 3. After the bulb airflow 34 efficiently cools the heat generating portion, high temperature airflows could be adequately mixed with cold airflows by the guiding plate 10 and then discharged from the system.

The above-mentioned filter 9 can further form a virtual duck with the light source device 1 to guide the airflow 34 which is generated from the second axial fan 3. In short, the filter 9 and the light source device 1 form a cooling airflow channel therebetween to facilitate the lamp cooling. The cooling airflow channel comprises a broad airflow inlet 91 and a narrow airflow outlet 92, wherein the second axial fan 3 is located on the broad airflow inlet 91 and the guiding plate 10 is located on the narrow airflow outlet 92. This arrangement enlarges the airflow inlet space for the second axial fan 3 to reduce incoming airflow losses. It is understandable that the filter 9 and the guiding plate 10 are provided to constitute the field of airflow generating from the second axial fan 3 to enhance cooling efficiencies.

The bulb 111 has a working temperature threshold of 900° (in Celsius) and the lead wire 112 has a working temperature threshold of 350° (in Celsius). According to the disclosures of the present invention, the DLP projection system could be maintained at a temperature under the thresholds. Furthermore, the noises, costs, and volume are greatly reduced.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A cooling device for use with a projection apparatus, wherein the projection apparatus comprises a light source device, which has a heat generating portion, the cooling device comprising:
a first axial fan;
a second axial fan disposed at a side of the heat generating portion; wherein the first axial fan and the second axial fan are adapted to guide an external airflow toward the light source device, and the second axial fan comprising:
an inner end;
an outer end disposed opposing to the inner end; and
an airflow guiding device, disposed onto the outer end, in which the airflow guiding device comprises an airflow outlet and an airflow inlet having an area greater than that of the airflow outlet, and the airflow inlet shields at least a portion of the outer end of the second axial fan.

2. The cooling device for use with a projection apparatus as claimed in claim 1, wherein the light source device is a lamp, comprising:
a bulb;
a lead wire disposed in front of the bulb; and
a reflector comprising a neck portion and an opening, the bulb located in the neck portion of the reflector, and the lead wire substantially located in the opening, whereby the bulb and the lead wire co-define the heat generating portion;
wherein the first axial fan is adapted to guide the external airflow toward the neck portion of the lamp.

3. The cooling device for use with a projection apparatus as claimed in claim 1, wherein the airflow inlet of the airflow guiding device shields substantially a half portion of the outer end of the second axial fan and the airflow outlet is disposed substantially toward the heat generating portion.

4. The cooling device for use with a projection apparatus as claimed in claim 3, wherein the airflow guiding device is integrally formed with the outer end of the second axial fan.

5. The cooling device for use with a projection apparatus as claimed in claim 1, wherein the airflow inlet of the airflow guiding device completely shields the outer end of the second axial fan and the airflow outlet is disposed substantially toward the heat generating portion.

6. The cooling device for use with a projection apparatus as claimed in claim 5, wherein the airflow guiding device further comprises a system airflow outlet and a partition disposed between the airflow outlet and the system airflow outlet.

7. The cooling device for use with a projection apparatus as claimed in claim 5, wherein the airflow guiding device is integrally formed with the outer end of the second axial fan.

8. The cooling device for use with a projection apparatus as claimed in claim 1, wherein the projection apparatus is a digital light processing (DLP) projector.

9. The cooling device for use with a projection apparatus as claimed in claim 1, wherein the projection apparatus further comprises an optical engine chassis, and the cooling device further comprises:
a first fastening device, mounting the airflow guiding device to the outer end of the second axial fan; and
a second fastening device, mounting the airflow guiding device to the optical engine chassis.

10. A cooling device for use with a projection apparatus, wherein the projection apparatus comprises a light source device which has an optical axis and a heat generating portion disposed on the optical axis, the cooling device comprising:
a first axial fan;
a second axial fan disposed at a side of the heat generating portion; wherein the first axial fan and the second axial fan are disposed at a same side in view of the light source device for guiding an external airflow toward the light source device, the second axial fan comprising:
an inner end;
an outer end disposed opposing to the inner end;
an airflow guiding device, disposed onto the outer end, in which the airflow guiding device comprises an airflow outlet and an airflow inlet having an area greater than that of the airflow outlet, and the airflow inlet shields at least a portion of the outer end of the second axial fan;
a filter disposed in front of the light source device to form an angle with the optical axis in favor to air flow; and
a guiding plate disposed at a side opposing to the second axial fan.

11. The cooling device for use with a projection apparatus as claimed in claim 10, wherein the light source device is a lamp comprising:
a bulb;
a lead wire disposed in front of the bulb; and
a reflector comprising a neck portion and an opening, the bulb located in the neck portion of the reflector, and the lead wire substantially located in the opening, whereby the bulb and the lead wire co-define the heat generating portion;
wherein the first axial fan is adapted to guide the external airflow toward the neck portion of the lamp.

12. The cooling device for use with a projection apparatus as claimed in claim 10, wherein the airflow inlet of the airflow guiding device shields substantially a half portion of the outer end of the second axial fan and the airflow outlet is disposed substantially toward the heat generating portion.

13. The cooling device for use with a projection apparatus as claimed in claim 12, wherein the airflow guiding device is integrally formed with the outer end of the second axial fan.

14. The cooling device for use with a projection apparatus as claimed in claim 10, wherein the airflow inlet of the airflow guiding device completely shields the outer end of the second axial fan and the airflow outlet is disposed substantially toward the heat generating portion.

15. The cooling device for use with a projection apparatus as claimed in claim 14, wherein the airflow guiding device further comprises a system airflow outlet and a partition disposed between the airflow outlet and the system airflow outlet.

16. The cooling device for use with a projection apparatus as claimed in claim 14, wherein the airflow guiding device is integrally formed with the outer end of the second axial fan.

17. The cooling device for use with a projection apparatus as claimed in claim 10, wherein the projection apparatus is a digital light processing (DLP) projector.

18. The cooling device for use with a projection apparatus as claimed in claim 17, wherein the filter is an ultraviolet infra-red (UV-IR) cut filter

19. The cooling device for use with a projection apparatus as claimed in claim 18, wherein the filter and the light source device form a cooling airflow channel therebetween, the cooling airflow channel comprising a broad airflow inlet and a narrow airflow outlet, wherein the second axial fan is located at the broad airflow inlet and the guiding plate located at the narrow airflow outlet.

20. The cooling device for use with a projection apparatus as claimed in claim 10, wherein the projection apparatus further comprises an optical engine chassis, and the cooling device further comprises:
a first fastening device, mounting the airflow guiding device to the outer end of the second axial fan; and
a second fastening device, mounting the airflow guiding device to the optical engine chassis.
